(19) United States
(12) Patent Application Publication
(10) Pub. No.: US 2018/0007122 A1
(43) Pub. Date: Jan. 4, 2018

(54) DATA CENTER RESELECTION

(71) Applicant: Microsoft Technology Licensing, LLC, Redmond, WA (US)

(72) Inventors: Danny Levin, Tel Aviv (IL); Bradford R. Clark, Broomfield, CO (US); Amer Hassan, Kirkland, WA (US); Russell Andrew Penar, Highlands Ranch, CO (US)

(21) Appl. No.: 15/198,736

(22) Filed: Jun. 30, 2016

(51) Int. Cl. H04L 29/08; H04L 12/733; H04L 29/06; H04M 7/00

(52) U.S. Cl. CPC H04L 67/1002; H04M 7/006; H04L 45/122; H04L 65/403; H04L 67/148

(57) ABSTRACT

An initial data center is selected to host the online conference. This data center can be selected based on the locations of the participants, a weighting (or ‘priority’) of the participants, or a combination of the two (e.g., locations that are weighted by the participant's priority.) Typically, the data center closest to the centroid (i.e., geometric center, or ‘center of mass’) of the participants is selected. In anticipation that participants will join and/or leaver the conference, a list is calculated that each possible change to a respective data center that will be selected if that change occurs. This list may be distributed to the data centers that, if selected, would host the online conference.

### BACKGROUND

Online conferencing (a.k.a., web conferencing and/or internet conferencing) systems have an array of capabilities including voice/video communications, instant messaging, data/application sharing, and white-boarding. These online collaborative service systems enable users to engage in communication sessions to exchange different types of communication media, such as voice data, video data, content sharing, and combinations thereof. Some conferencing systems enable users to share and collaborate in creating and modifying documents or other shared content. Online conferencing typically allows real-time point-to-point communication as well as multicast communications (i.e., from one sender to many receivers.) Some services offer data streams of voice and/or video chat to be shared simultaneously, across geographically dispersed locations. Applications for online conferencing include meetings, training events, lectures, and presentations.

### SUMMARY

Examples discussed herein relate to a method for handing-off conference calls among data centers. This method includes selecting, from among a plurality of data centers, an initial data center to host a conference call. This conference call has participants on the conference call that include a first plurality of participants that are each associated with one of a first plurality of participant locations. The selection of the initial data center is based, at least in part, on the first plurality of participant locations. The method also includes determining ahead of time which data center of the plurality of data centers to associate with each of a plurality of anticipated changes to the participants on the conference call. One of the plurality of anticipated changes corresponding to the participants on the conference call changing to a second plurality of participants each associated with one of a second plurality of participant locations. The method further includes, in response to at least a change occurring in the participants on the conference call such that the participants on the conference call becomes the second plurality of participants, identifying a data center that was determined earlier to be associated with the participants on the conference call becoming the second plurality of participants. And, the method further includes handing-off the conference call to the identified data center if the data center differs from the initial data center.

In an example, a communication system includes: an initial data center of a plurality of data centers to initially host a conference call. The conference call has participants on the conference call that include a first plurality of participants each associated with one of a first plurality of participant locations. The selection of the initial data center is based at least in part on the first plurality of participant locations. The system further includes a handoff system that determines ahead of time a respective data center of the plurality of data centers to associate with each of a plurality of anticipated changes to the participants on the conference call. One of these plurality of anticipated changes corresponds to the participants on the conference call changing to a second plurality of participants. Each of these second plurality of participants is associated with one of a second plurality of participant locations. The system further includes an identified data center of the plurality of data centers to host the conference call based on an ahead of time determination by the handoff system and the corresponding change occurring to the participants on the conference call such that the participants on the conference call becomes the second plurality of participants.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1A is a block diagram illustrating an online conferencing system.

FIG. 1B is an illustration of an initial location centroid of an online conference.

FIG. 1C is an illustration of a changed location centroid of an online conference.

FIG. 1D is an illustration of a weighted centroid of an online conference.

FIG. 1E is an illustration of a conference system that distributes anticipated changes and associated data centers.

FIG. 2 is an illustration of a list of anticipated changes and associated data centers.

FIG. 3 is a flowchart illustrating a method of handing-off an online conference based on participant locations.

FIG. 4 is a flowchart illustrating a method of handing-off an online conference based on participant profiles.

FIG. 5 is a block diagram illustrating a computer system.

### DETAILED DESCRIPTION OF THE EMBODIMENTS

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a computing device, or a computer readable medium.

Participants in an online conference call may join or leave while the call is in progress. If significant geographical or connectivity changes occur in the makeup of the participants in a call occur, there may be a better (e.g., faster, better quality, more efficient) data center than the current one to host the call. Likewise, if important participants (e.g., presenters, high-level executives, remote auditorium, etc.) join or leave the call, the call may be better hosted by a different (i.e., better) data center.

In an embodiment, an initial data center is selected to host the online conference. This data center can be selected based on the locations of the participants, a weighting (or ‘priority’) of the participants, or a combination of the two (e.g., locations that are weighted by the participant's priority.) Typically, the data center closest to the centroid (i.e., geometric center, or ‘center of mass’) of the participants is selected. In anticipation that participants will join and/or leaver the conference, a list is calculated that each possible change to a respective data center that will be selected if that change occurs. This list may be distributed to the data centers that, if selected, would host the online conference. Thus, when the participants on the call change (e.g., someone joins or leaves), a new data center (if any) is selected based on these pre-calculated selections. This allows for the efficient reselection of data centers as participation in the conference changes because the reselection is done based on a pre-calculated list of selections rather than re-calculating the centroid each time a participant joins and/or leaves the conference.

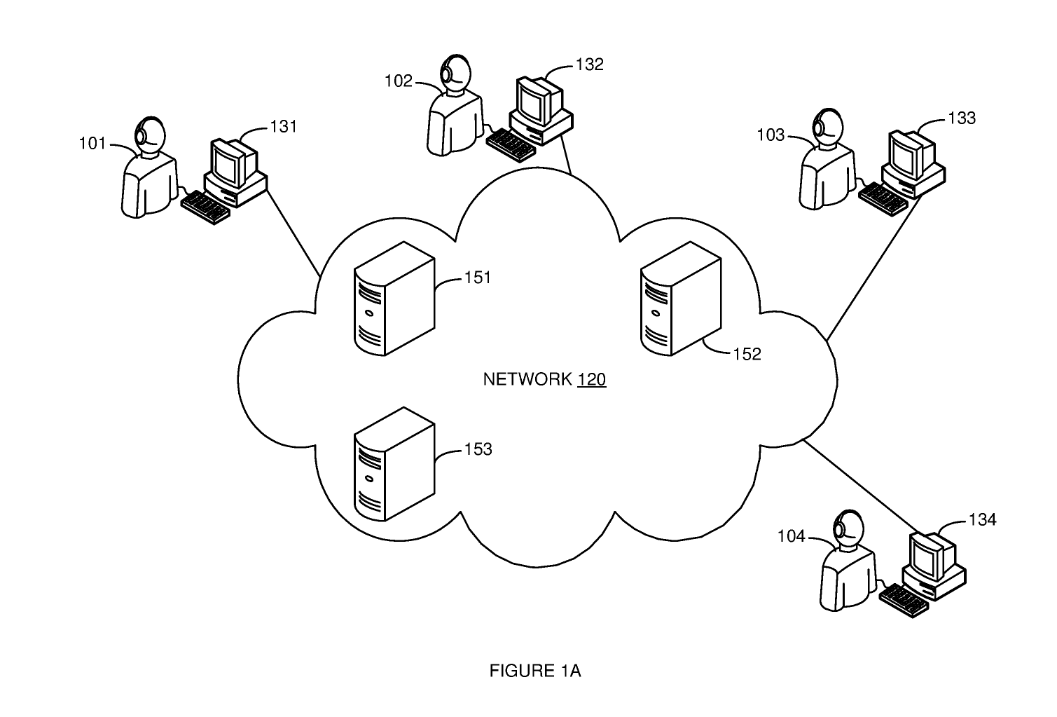

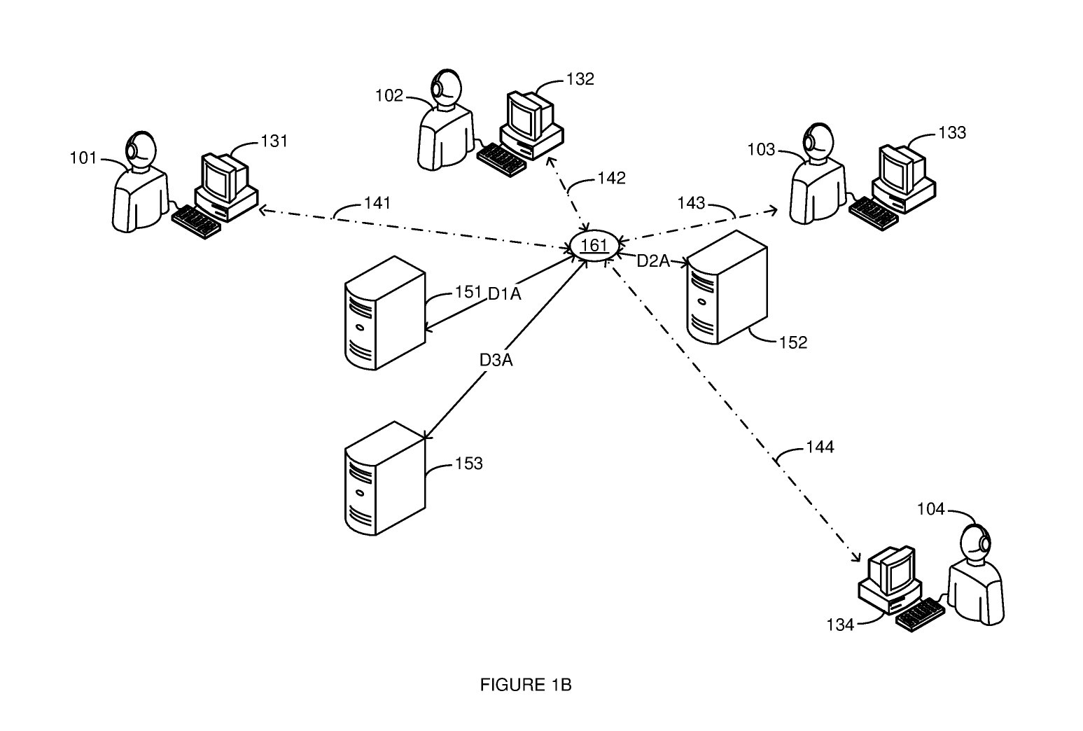

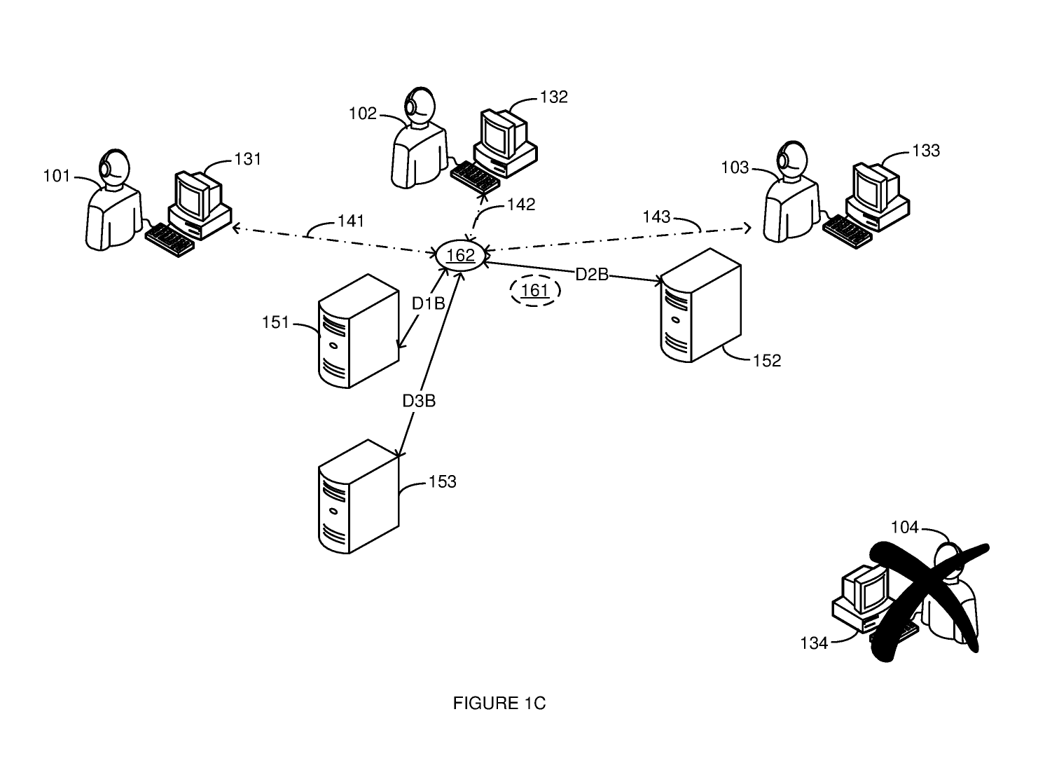

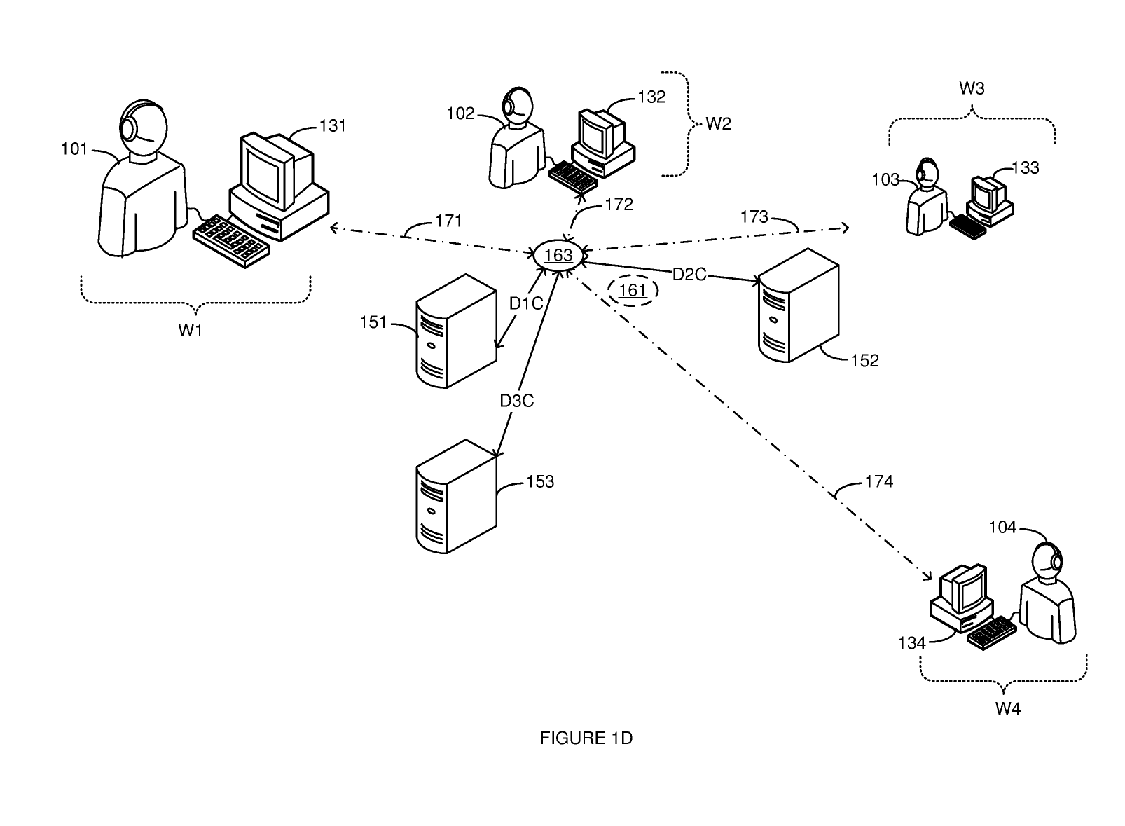

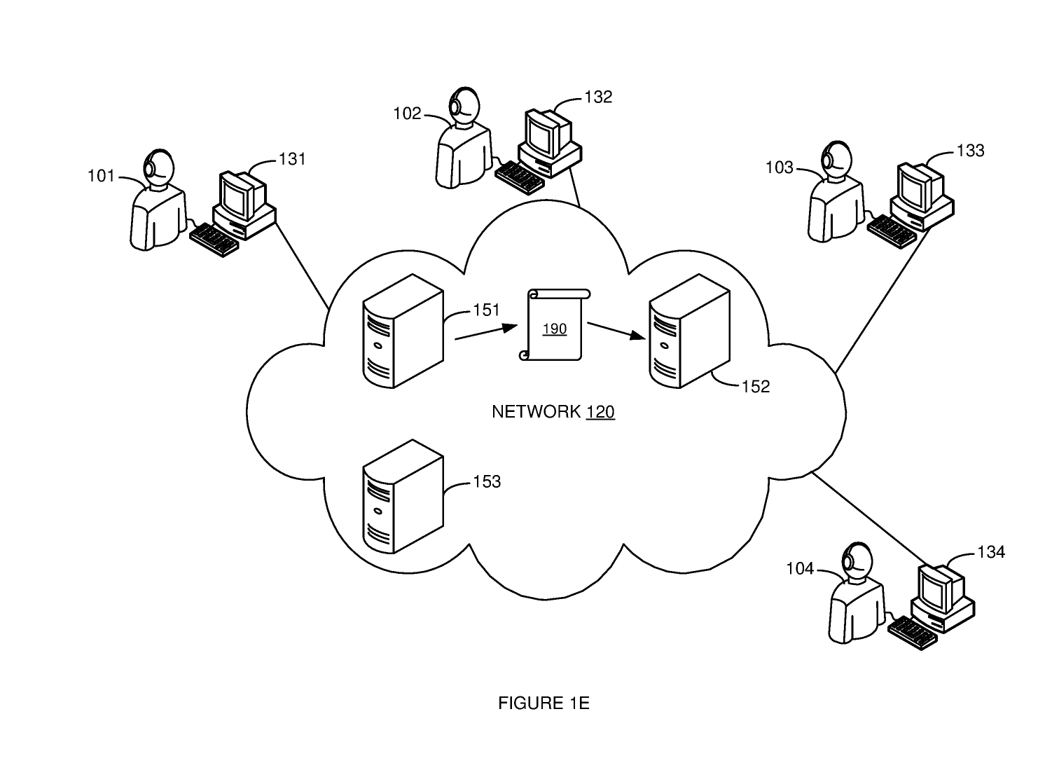

FIG. 1A is a block diagram illustrating an online conferencing system. In FIG. 1A, conferencing system 100 comprises participants 101-104, client devices 131-134, network 120, and data centers 151-153. Participants 101-104 use a software program deployed on client devices 131-134, respectively, to participate in an online conference hosted by a selected one of data centers 151-153. Client devices 131-134 are operatively coupled to network 120. Network 120 includes, or is operatively coupled to, data centers 151-153. Thus, participants 101-104, via client devices 131-134, network 120, and a selected data center 151-153 are able to join, leave, receive, and participate in, an online conference call.

Network 120 is a wide area communication network that can provide wired and/or wireless communication with data centers 151-153 by client devices 131-134. Network 120 and can comprise wired and/or wireless communication networks that include processing nodes, routers, gateways, physical and/or wireless data links for carrying data among various network elements, including combinations thereof, and can include a local area network, a wide area network, and an internetwork (including the Internet). Network 120 can also comprise wireless networks, including base station, wireless communication nodes, telephony switches, internet routers, network gateways, computer systems, communication links, or some other type of communication equipment, and combinations thereof. Wired network protocols that may be utilized by network 120 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Links between elements of network 120, can be, for example, twisted pair cable, coaxial cable or fiber optic cable, or combinations thereof.

Other network elements may be present in network 120 to facilitate communication but are omitted for clarity, such as base stations, base station controllers, gateways, mobile switching centers, dispatch application processors, and location registers such as a home location register or visitor location register. Furthermore, other network elements may be present to facilitate communication between among elements of conferencing system 100 which are omitted for clarity, including additional computing devices, client devices, access nodes, routers, gateways, and physical and/or wireless data links for carrying data among the various network elements.

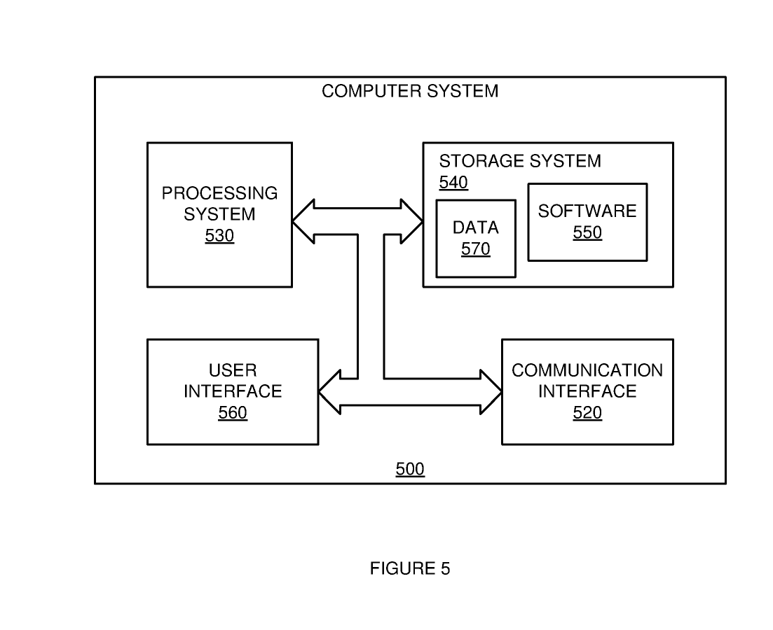

Client devices 131-134 may be, for example, a desktop computer, a tablet computer, a laptop computer, a mobile phone, a wireless phone, a personal digital assistant (PDA), a voice over internet protocol (VoIP) phone, a voice over packet (VOP) phone, or a soft phone, as well as other types of devices or systems that execute a web browser and/or conferencing software (for example, the Skype™ app from Microsoft) in order to participate in a conference hosted by a data center 151-153. Other types of communication platforms are possible. An example device that may be, comprise, and/or include a client device 131-134 include, but are not limited to, example computer system 500 (described herein with reference to FIG. 5).

In an embodiment, conferencing system 100 selects from among data centers 151-153 an initial data center to host a conference call. This selection may be made by one or more of data centers 151-153, and element of data centers 151-153, or another system not shown in FIG. 1 (e.g., a data center selection and/or handoff system residing at and/or coupled to a data center 151-153.) This selection is based at least in part on the locations of the initial participants 101-104.

In particular, the selection of an initial data center may be based on a centroid calculated from the locations of participants 101-104 (as reflected and/or reported by the locations of client devices 131-134.) FIG. 1B is an illustration of an initial location centroid of an online conference. FIG. 1B illustrates conferencing system 100. For clarity purposes, network 120 is not illustrated in FIG. 1B (though it should be understood that network 120 is still part of conferencing system 100 as illustrated in FIG. 1A.)

In FIG. 1B, the geometric centroid 161 of the locations of client devices 131-134 (and therefore the locations of participants 101-104) is illustrated. Geometric centroid 161 is a weighted average of geometric distances. Thus, for example, if client device 131 is in an area of poor connectivity, then the geometric weight contributed to the location of the centroid by client device 131 is higher than it would be for the same location, but with better connectivity. If the weighting go the geometric distances is equal to one (1), the geometric centroid is the same as the geographic centroid.

The contribution of the locations of client devices 131-134 are illustrated in FIG. 1B by arrows 141-144, respectively. Arrows 141-144 are illustrated running between respective client devices 131-134 and centroid 161. The distances between data centers 151-153 and centroid 161 is illustrated in FIG. 1B by arrows D1A, D2A, and D3A, respectively. Arrows D1A, D2A, and D3A are illustrated as running between respective data centers 151-153 and centroid 161. Thus, in FIG. 1B, D1A is the distance between data center 151 to centroid 161; D2A is the distance between data center 152 to centroid 161; and D3A is the distance between data center 153 to centroid 161. In FIG. 1B D2A is less than D1A and D1A is less than D3A. Thus, system 100 would select data center 152 to host the conference call based on data center 152 being closest to the centroid 161 of participants 101-104 in FIG. 1B.

Conferencing system 100 also determines ahead of time which data center 151-153 to associate with anticipated changes to the participants on the conference call. In other words, conferencing system 100 determines, in advance, which data center 151-153 will be selected when each one of a set of possible changes to the set of participants occurs.

In an embodiment, this set of changes may be an exhaustive set of all possible changes that could occur over the course of the conference call. In another embodiment, this set of changes may be limited to a certain number of participants joining and/or leaving the conference call. For example, the set of changes that are each associated with a data center 151-153 to hosting a call may be limited to the set of possible changes that involve no more than M number of participants joining and/or leaving the call, where M is a positive integer. In other words, if M=2, the set of possible changes may include all possible changes to the participants that involve up to two participants joining or leaving the call. These selections may be made by one or more of data centers 151-153, and element of data centers 151-153, or another system not shown in FIG. 1 (e.g., a data center selection and/or handoff system residing at and/or coupled to a data center 151-153.) The selection of a data center for each of these anticipated changes is based at least in part on the locations of the anticipated set of participants 101-104.

The set of possible changes may be expressed in terms of the participants on the call after the change occurs. In other words, a given change (e.g., participant 104 leaving the call) may be expressed in terms of the set of participants that are on the conference call after the change occurs (e.g., participants 101-103 would remain on the call after participant 104 leaves.) Thus, any given anticipated change, regardless of the number of participants joining and/or leaving the conference call, can be associated with the set of participants on the call after the change occurs.

In an embodiment, the selection of the data center 151-153 to host the conference call if a given change occurs may be based on a centroid calculated from the locations of the participants 101-104 that will be on the conference call if that given change occurs (as reflected and/or reported by the locations of client devices 131-134.) In an embodiment, the data center 151-153 selected to host the conference is the one that is closest to the calculated centroid. In another embodiment, if it is determined that selection of a farther away data center will not significantly impact the quality experienced by users 101-104, the data center 151-153 selected may be a different data center 151-153 that the closest one.

FIG. 1C is an illustration of how a location centroid of an online conference may move as a result of a change in the participants on a conference call. FIG. 1C illustrates conferencing system 100. For clarity purposes, network 120 is not illustrated in FIG. 1C (though it should be understood that network 120 is still part of conferencing system 100 as illustrated in FIG. 1A.)

In FIG. 1C, the current geometric centroid 161 of the locations of client devices 131-134 (and therefore the locations of participants 101-104) is illustrated. An anticipated geometric centroid 162 after a change occurs is also illustrated. In FIG. 1C, the anticipated change illustrated corresponds to participant 104 leaving the conference call (alternately, this can be viewed as the set of participants becoming participants 101-103.)

The contributions of the locations of client devices 131-133 is illustrated in FIG. 1C by arrows 141-144, respectively. Arrows 141-144 are illustrated running between respective client devices 131-133 and centroid 162. The distances between data centers 151-153 and centroid 162 is illustrated in FIG. 1C by arrows D1B, D2B, and D3B, respectively. Arrows D1B, D2B, and D3B are illustrated as running between respective data centers 151-153 and centroid 162. Thus, in FIG. 1C, D1B is the distance between data center 151 to centroid 162; D2B is the distance between data center 152 to centroid 162; and D3B is the distance between data center 153 to centroid 162. In FIG. 1C D1B is less than D2B and D2B is less than D3B. Thus, system 100 would, in advance, select data center 151 to host the conference call if a change occurred that results in participants 101-103 being the participants on the conference call. This selection is based on data center 151 being closest to the centroid 162 of participants 101-103 in FIG. 1C.

In an embodiment, the selection of the data center 151-153 to host the conference call, either initially or if a given change occurs, may be based on a centroid calculated from a weighted location for each of the participants 101-104 that will be on the conference call. FIG. 1D is an illustration of how a weighted location centroid of an online conference may move as a result of a change in the participants on a conference call. FIG. 1D illustrates conferencing system 100. For clarity purposes, network 120 is not illustrated in FIG. 1D (though it should be understood that network 120 is still part of conferencing system 100 as illustrated in FIG. 1A.)

In FIG. 1D, each of participants 101-104 is associated with a respective weighting factor W1-W4. The weighting factors W1-W4 may be arbitrarily assigned to each participant 101-104. The weighting factors W1-W4 may be assigned as part of a participant 101-104 profile that is associated with each participant. For example, if participant 101 is the CEO of a company, participant 101 may be assigned a larger value for weighting factor W1 than the weighting factors W2-W4 participants 102-104 are assigned. Likewise, participants 101-104 may be assigned weighting factors based on being an anticipated presenter, is or will be sharing video or other resource intensive content/media, is the meeting host, or otherwise merits greater performance

In FIG. 1D, the unweighted geometric centroid 161 of the locations of client devices 131-134 (and therefore the locations of participants 101-104) is illustrated. A weighted geometric centroid 163 (either initial or anticipated) is also illustrated.

The contributions of the weighted locations of client devices 131-133 to the location of weighted centroid 163 is illustrated in FIG. 1D by arrows 171-174, respectively. Arrows 171-174 are illustrated running between respective client devices 131-133 and centroid 163. The distances between data centers 151-153 and centroid 163 is illustrated in FIG. 1D by arrows D1C, D2C, and D3C, respectively. Arrows D1C, D2C, and D3C are illustrated as running between respective data centers 151-153 and centroid 163. Thus, in FIG. 1D, D1C is the distance between data center 151 to centroid 163; D2C is the distance between data center 152 to centroid 163; and D3C is the distance between data center 153 to centroid 163. In FIG. 1D D1D is less than D2DB and D2D is less than D3D. Thus, system 100 would, initially and in advance, select data center 151 to host the conference This selection is based on data center 151 being closest to the weighted centroid 163 of participants 101-104 in FIG. 1D.

When a change occurs to the participants 101-104 in the conference call, the data center 151-153 associated with that change is identified from the corresponding anticipated change. In other words, if a first set of participants changes to a second set of participant (either by one or more participants 101-104 joining the call, leaving the call, or both) the data center 151-153 previously selected to host the conference call when there is the second set of participants is identified as the host that should be hosting the conference call. If the identified data center is not the data center currently hosting the conference call (e.g., the initial data center if this is the first change to the participants on the conference call), the conference call is handed-off to the identified data center.

The list of anticipated changes and respectively associated data centers 151-153 may be distributed to data centers 151-153. In an embodiment, this list may be distributed to all data centers 151-153. In an embodiment, this list may be distributed only to data centers 151-153 that have an association to an anticipated change on the list. In other words, if there is no anticipated combination of participants that would result in a particular data center (e.g., data center 153) hosting the conference call, the list will not necessarily be distributed to that data center 151-153.

FIG. 1E is an illustration of a conference system that distributes anticipated changes and associated data centers. In FIG. 1E, data center 151 (e.g., if data center 151 contains a handoff system that determines the data center 151-153 to anticipated change associations) distributes indicators 191 of the anticipated changes and respectively associated data centers to data center 152. This is illustrated in FIG. 1E by the arrow leading from data center 151 to indicators 191 and the arrow from indicators 191 to data center 152.

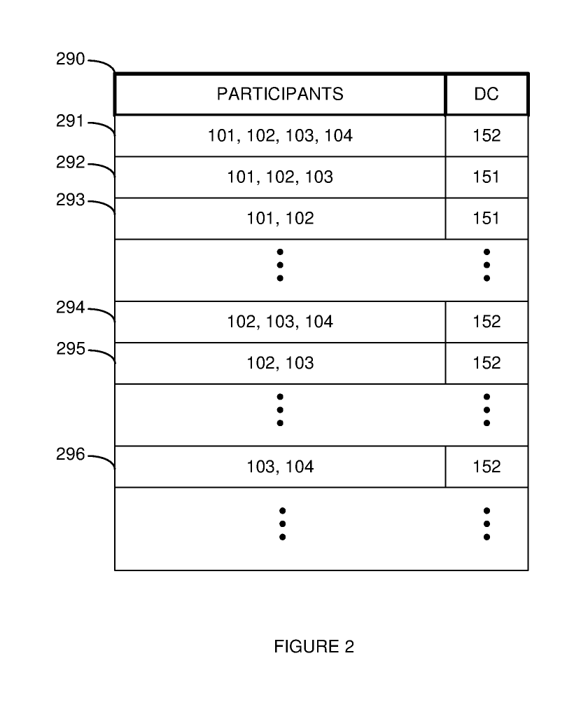

FIG. 2 is an illustration of a list of anticipated changes and associated data centers. In FIG. 2, list 290 is illustrated as comprising of rows 291-296. Each of rows 291-296 includes a field for participants and a field for the associated data center (DC). Row 291 associates an anticipated change where participants 101, 102, 103, and 104 end up being on the conference call to data center 152. Row 292 associates an anticipated change where participants 101, 102, and 103, end up being on the conference call to data center 151. Row 293 associates an anticipated change where participants 101 and 102 end up being on the conference call to data center 151. Row 294 associates an anticipated change where participants 102, 103, and 104 end up being on the conference call to data center 152. Row 295 associates an anticipated change where participants 102 and 103 end up being on the conference call to data center 152. Row 296 associates an anticipated change where participants 103 and 104 end up being on the conference call to data center 152.

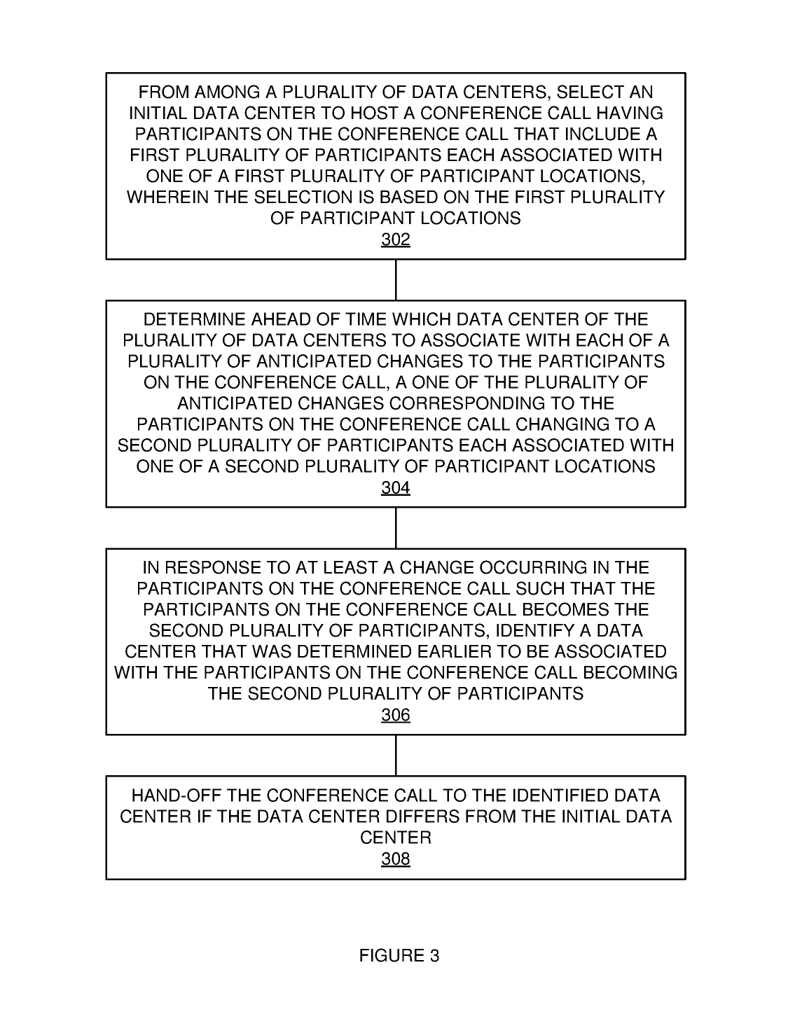

FIG. 3 is a flowchart illustrating a method of handing-off an online conference based on participant locations. The steps illustrated in FIG. 3 may be performed by one or more elements of conferencing system 100. From among a plurality of data centers, an initial data center is selected to host a conference call having participants on the conference call that include a first plurality of participants each associated with one of a first plurality of participant locations, wherein the selection is based on the first plurality of participant locations (302). For example, conferencing system 100 may select, from among data centers 151-153, an initial data center (e.g., data center 151) to host a conference call. This selection may be made by one or more of data centers 151-153, and element of data centers 151-153, or another system not shown in FIG. 1 (e.g., a data center selection and/or handoff system residing at and/or coupled to a data center 151-153.) This selection is based at least in part on the locations of the initial participants 101-104. In particular, the selection of an initial data center may be based on a centroid calculated from the locations of participants 101-104 (as reflected and/or reported by the locations of client devices 131-134.)

Ahead of time it is determined which data center of the plurality of data centers to associate with each of a plurality of anticipated changes to the participants on the conference call. A one of the plurality of anticipated changes corresponding to the participants on the conference call changing to a second plurality of participants each associated with one of a second plurality of participant locations (304). For example, Conferencing system 100 may determine ahead of time which data center 151-153 to associate with anticipated changes to the participants 101-104 on the conference call. In other words, conferencing system 100 may determine, in advance, which data center 151-153 will be selected when each one of a set of possible changes to the set of participants occurs.

This set of changes may be an exhaustive set of all possible changes that could occur over the course of the conference call. In another embodiment, this set of changes may be limited to a certain number of participants joining and/or leaving the conference call. These selections may be made by one or more of data centers 151-153, and element of data centers 151-153, or another system not shown in FIG. 1 (e.g., a data center selection and/or handoff system residing at and/or coupled to a data center 151-153.) The selection of a data center for each of these anticipated changes is based at least in part on the locations of the anticipated set of participants 101-104. The set of possible changes may be expressed in terms of the participants on the call after the change occurs. In other words, a given change (e.g., participant 104 leaving the call) may be expressed in terms of the set of participants that are on the conference call after the change occurs (e.g., participants 101-103 would remain on the call after participant 104 leaves.)

In response to at least a change occurring in the participants on the conference call such that the participants on the conference call becomes the second plurality of participants, a data center that was determined earlier to be associated with the participants on the conference call becoming the second plurality of participants is identified (306). For example, when a first set of participants changes to a second set of participants (either by one or more participants 101-104 joining the call, leaving the call, or both) the data center 151 previously selected to host the conference call when there is the second set of participants is identified as the host that should be hosting the conference call.

The conference call is handed-off to the identified data center if the data center differs from the initial data center (308). For example, if the identified data center (e.g., data center 151) is not the data center currently hosting the conference call (e.g., data center 152), the conference call is handed-off to the identified data center.

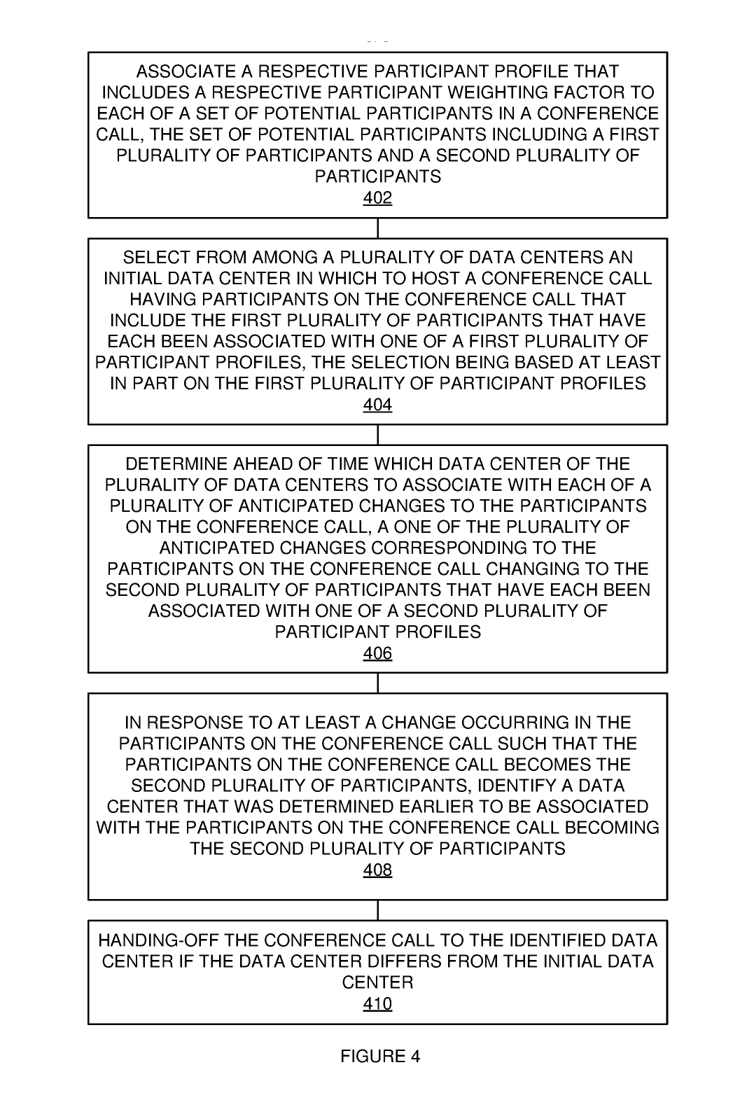

FIG. 4 is a flowchart illustrating a method of handing-off an online conference based on participant profiles. The steps illustrated in FIG. 4 may be performed by one or more elements of conferencing system 100. A respective participant profile that includes a respective participant weighting factor is associated to each of a set of potential participants in a conference call. The set of potential participants includes a first plurality of participants and a second plurality of participants (402). For example, each of participants 101-104 may be associated with a respective weighting factor W1-W4. The weighting factors W1-W4 may be arbitrarily assigned to each participant 101-104. The weighting factors W1-W4 may be assigned as part of a participant 101-104 profile that is associated with each participant. For example, if participant 101 is the CEO of a company, participant 101 may be assigned a larger value for weighting factor WI than the W2-W4 factors participants 102-104 are assigned. Likewise, participants 101-104 may be assigned weighting factors W1-W4 based on being an anticipated presenter, is or will be sharing video or other resource intensive content/media, is the meeting host, or otherwise merits greater performance

From among a plurality of data centers, an initial data center is selected in which to host a conference call having participants on the conference call that include the first plurality of participants that have each been associated with one of a first plurality of participant profiles. This selection is based at least in part on the first plurality of participant profiles (404). For example, conferencing system 100 may select, from among data centers 151-153, an initial data center (e.g., data center 151) to host a conference call. This selection may be made by one or more of data centers 151-153, and element of data centers 151-153, or another system not shown in FIG. 1 (e.g., a data center selection and/or handoff system residing at and/or coupled to a data center 151-153.) This selection is based at least in part on the participant profiles associated with participants 101-104. These participant profiles may include a weighting factor and/or a location. In particular, the selection of an initial data center may be based on a centroid calculated from a combination of the locations of participants 101-104 (as reflected and/or reported by the locations of client devices 131-134) and the weighting factors associated with each of participants 101-104.

Ahead of time it is determined which data center of the plurality of data centers to associate with each of a plurality of anticipated changes to the participants on the conference call. A one of the plurality of anticipated changes corresponding to the participants on the conference call changing to the second plurality of participants that have each been associated with one of a second plurality of participant profiles (406). For example, Conferencing system 100 may determine ahead of time which data center 151-153 to associate with anticipated changes to the participants 101-104 on the conference call. In other words, conferencing system 100 may determine, in advance, which data center 151-153 will be selected when each one of a set of possible changes to the set of participants occurs.

In response to at least a change occurring in the participants on the conference call such that the participants on the conference call becomes the second plurality of participants, a data center that was determined earlier to be associated with the participants on the conference call becoming the second plurality of participants is identified (408). For example, when a first set of participants changes to a second set of participants (either by one or more participants 101-104 joining the call, leaving the call, or both) the data center 151 previously selected to host the conference call when there is the second set of participants is identified as the host that should be hosting the conference call.

The conference call is handed-off to the identified data center if the data center differs from the initial data center (410). For example, if the identified data center (e.g., data center 151) is not the data center currently hosting the conference call (e.g., data center 152), the conference call is handed-off to the identified data center.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of deployed software system 100 and its components. These software descriptions may be: behavioral, register transfer, logic component, transistor, and layout geometry-level descriptions.

Data formats in which such descriptions may be implemented are stored on a non-transitory computer readable medium include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Physical files may be implemented on non-transitory machine-readable media such as: 4 mm magnetic tape, 8 mm magnetic tape, 3½-inch floppy media, CDs, DVDs, hard disk drives, solid-state disk drives, solid-state memory, flash drives, and so on.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

FIG. 5 illustrates a block diagram of an example computer system. Computer system 500 includes communication interface 520, processing system 530, storage system 540, and user interface 560. Processing system 530 is operatively coupled to storage system 540. Storage system 540 stores software 550 and data 570. Processing system 530 is operatively coupled to communication interface 520 and user interface 560. Computer system 500 may comprise a programmed general-purpose computer. Computer system 500 may include a microprocessor. Computer system 500 may comprise programmable or special purpose circuitry. Computer system 500 may be distributed among multiple devices, processors, storage, and/or interfaces that together comprise elements 520-570.

Communication interface 520 may comprise a network interface, modem, port, bus, link, transceiver, or other communication device. Communication interface 520 may be distributed among multiple communication devices. Processing system 530 may comprise a microprocessor, microcontroller, logic circuit, or other processing device. Processing system 530 may be distributed among multiple processing devices. User interface 560 may comprise a keyboard, mouse, voice recognition interface, microphone and speakers, graphical display, touch screen, or other type of user interface device. User interface 560 may be distributed among multiple interface devices. Storage system 540 may comprise a disk, tape, integrated circuit, RAM, ROM, EEPROM, flash memory, network storage, server, or other memory function. Storage system 540 may include computer readable medium. Storage system 540 may be distributed among multiple memory devices.

Processing system 530 retrieves and executes software 550 from storage system 540. Processing system 530 may retrieve and store data 570. Processing system 530 may also retrieve and store data via communication interface 520. Processing system 550 may create or modify software 550 or data 570 to achieve a tangible result. Processing system may control communication interface 520 or user interface 560 to achieve a tangible result. Processing system 530 may retrieve and execute remotely stored software via communication interface 520.

Software 550 and remotely stored software may comprise an operating system, utilities, drivers, networking software, and other software typically executed by a computer system. Software 550 may comprise an application program, applet, firmware, or other form of machine-readable processing instructions typically executed by a computer system. When executed by processing system 530, software 550 or remotely stored software may direct computer system 500 to operate as described herein.

Implementations discussed herein include, but are not limited to, the following examples:

Example A1: A method for handing-off conference calls among data centers, the method comprising: selecting, from among a plurality of data centers, an initial data center to host a conference call having participants on the conference call that include a first plurality of participants each associated with one of a first plurality of participant locations, the selection being based at least in part on the first plurality of participant locations; determining ahead of time which data center of the plurality of data centers to associate with each of a plurality of anticipated changes to the participants on the conference call, a one of the plurality of anticipated changes corresponding to the participants on the conference call changing to a second plurality of participants each associated with one of a second plurality of participant locations; in response to at least a change occurring in the participants on the conference call such that the participants on the conference call becomes the second plurality of participants, identifying a data center that was determined earlier to be associated with the participants on the conference call becoming the second plurality of participants; and, handing-off the conference call to the identified data center if the data center differs from the initial data center.

Example A2: The method of example A1, further comprising: determining a first centroid using the first plurality of participant locations, the selection of the initial data center being based on the first centroid.

Example A3: The method of example A2, further comprising: determining a second centroid using the second plurality of participant locations, the determining ahead of time to be based at least in part on the second plurality of participant locations.

Example A4: The method of example A1, wherein the first plurality of participants has more participants than the second plurality of participants.

Example A5: The method of example A1, wherein the first plurality of participants has fewer participants than the second plurality of participants.

Example A6: The method of example A1, further comprising: distributing indicators of the plurality of anticipated changes and respectively associated data centers to at least one of the associated data centers.

Example A7: The method of example A1, wherein the indicators of the plurality of anticipated changes are not distributed to data centers that are not one of the respectively associated data centers.

Example A8:A communication system, comprising: an initial data center of a plurality of data centers to initially host a conference call having participants on the conference call that include a first plurality of participants each associated with one of a first plurality of participant locations, a selection of the initial data center being based at least in part on the first plurality of participant locations; a handoff system that determines ahead of time a respective data center of the plurality of data centers to associate with each of a plurality of anticipated changes to the participants on the conference call, a one of the plurality of anticipated changes corresponding to the participants on the conference call changing to a second plurality of participants each associated with one of a second plurality of participant locations; an identified data center of the plurality of data centers to host the conference call based on an ahead of time determination by the handoff system and a corresponding change occurring in the participants on the conference call such that the participants on the conference call becomes the second plurality of participants.

Example A9: The communication system of example A8, wherein the initial data center includes the handoff system.

Example A10: The communication system of example A8, wherein the selection of the initial data center is based on a first centroid determined from the first plurality of participant locations.

Example A11: The communication system of example A8, wherein the handoff system the ahead of time determination by the handoff system is based on a second centroid determined from the second plurality of participant locations.

Example A12: The communication system of example A8, wherein the first plurality of participants has more participants than the second plurality of participants.

Example A13: The communication system of example A8, wherein the first plurality of participants has fewer participants than the second plurality of participants.

Example A14: The communication system of example A8, wherein the handoff system distributes indicators of the plurality of anticipated changes and respectively associated data centers to at least the identified data center.

Example A15: The communication system of example A8, wherein the handoff system distributes indicators of the plurality of anticipated changes and respectively associated data centers to the respectively associated data centers.

Example A16: A non-transitory computer readable medium having instructions stored thereon for handing-off conference calls among data centers that, when executed by a computer, at least instruct the computer to: select from among a plurality of data centers an initial data center to host a conference call having participants on the conference call that include a first plurality of participants each associated with one of a first plurality of participant locations, the selection being based at least in part on the first plurality of participant locations; determine ahead of time which data center of the plurality of data centers to associate with each of a plurality of anticipated changes to the participants on the conference call, a one of the plurality of anticipated changes corresponding to the participants on the conference call changing to a second plurality of participants each associated with one of a second plurality of participant locations; in response to at least a change occurring in the participants on the conference call such that the participants on the conference call becomes the second plurality of participants, identify a data center that was determined earlier to be associated with the participants on the conference call becoming the second plurality of participants; and, handoff the conference call to the identified data center if the data center differs from the initial data center.

Example A17: The computer readable medium of example A16, wherein the computer is further instructed to: determine a first centroid using the first plurality of participant locations, the selection of the initial data center being based on the first centroid.

Example A18: The computer readable medium of example A17, wherein the computer is further instructed to: determine a second centroid using the second plurality of participant locations, the determining ahead of time to be based at least in part on the second plurality of participant locations.

Example A19: The computer readable medium of example A18, wherein the computer is further instructed to: distribute indicators of the plurality of anticipated changes and respectively associated data centers to at least one of the associated data centers.

Example A20: The computer readable medium of example A18, wherein the computer is further instructed to: distribute indicators of the plurality of anticipated changes and respectively associated data centers to the respectively associated data centers.

Example B1: A method for handing-off conference calls among data centers, the method comprising: associating a respective participant profile that includes a respective participant weighting factor to each of a set of potential participants in a conference call, the set of potential participants including a first plurality of participants and a second plurality of participants; selecting from among a plurality of data centers an initial data center to host a conference call having participants on the conference call that include the first plurality of participants that have each been associated with one of a first plurality of participant profiles, the selection being based at least in part on the first plurality of participant profiles; determining ahead of time which data center of the plurality of data centers to associate with each of a plurality of anticipated changes to the participants on the conference call, a one of the plurality of anticipated changes including the participants on the conference call changing to the second plurality of participants that have each been associated with one of a second plurality of participant profiles; in response to at least a change occurring in the participants on the conference call such that the participants on the conference call becomes the second plurality of participants, identifying a data center that was determined earlier to be associated with the participants on the conference call becoming the second plurality of participants; and, handing-off the conference call to the identified data center if the data center differs from the initial data center.

Example B2: The method of example B1, further comprising: determining a first centroid using the participant weighting factors in the first plurality of participant profiles, the selection of the initial data center being based on the first centroid.

Example B3: The method of example B2, further comprising: determining a second centroid using the participant weighting factors in the second plurality of participant profiles, the determining ahead of time to be based at least in part on the second centroid.

Example B4: The method of example B3, wherein the respective participant profiles further include a respective participant location.

Example B5: The method of example B4, wherein the first centroid is further based on the participant locations in the first plurality of participant profiles and the second centroid is further based on the participant locations in the second plurality of participant profiles.

Example B6: The method of example B1, wherein the second plurality of participant profiles each further include a respective participant location indicator, and the data center associated with the one of the plurality of anticipated changes corresponding to the participants on the conference call changing to the second plurality of participants is determined using the respective participant location indicators of the second plurality of participant profiles.

Example B7. The method of example B5, further comprising: distributing indicators of the plurality of anticipated changes and respectively associated data centers to at least one of the associated data centers.

Example B8: A communication system, comprising: an initial data center of a plurality of data centers to initially host a conference call having participants on the conference call that include a first plurality of participants each associated with one of a first plurality of participant profiles, a selection of the initial data center being based at least in part on the first plurality of participant profiles; a handoff system that determines ahead of time a respective data center of the plurality of data centers to associate with each of a plurality of anticipated changes to the participants on the conference call, a one of the plurality of anticipated changes corresponding to the participants on the conference call changing to a second plurality of participants each associated with one of a second plurality of participant profiles, each of the second plurality of participant profiles including a respective participant weighting factor; an identified data center of the plurality of data centers to host the conference call based on an ahead of time determination by the handoff system and a corresponding change occurring in the participants on the conference call such that the participants on the conference call becomes the second plurality of participants.

Example B9: The communication system of example B8, wherein the initial data center includes the handoff system.

Example B10: The communication system of example B8, wherein each of the first plurality of participant profiles include a respective participant weighting factor, and the selection of the initial data center is based on a first centroid determined using the participant weighting factors of the first plurality of participant profiles.

Example B11: The communication system of example B8, wherein the handoff system the ahead of time determination by the handoff system is based on a second centroid determined using the participant weighting factors of the second plurality of participant profiles.

Example B12: The communication system of example B8, wherein the first plurality of participants has more participants than the second plurality of participants.

Example B13: The communication system of example B 8, wherein the first plurality of participants has fewer participants than the second plurality of participants.

Example B14: The communication system of example B 8, wherein the handoff system distributes indicators of the plurality of anticipated changes and respectively associated data centers to at least the identified data center.

Example B15: The communication system of example B8, wherein the handoff system distributes indicators of the plurality of anticipated changes and respectively associated data centers to the respectively associated data centers.

Example B16: A non-transitory computer readable medium having instructions stored thereon for handing-off conference calls among data centers that, when executed by a computer, at least instruct the computer to: associate a respective participant profile that includes a respective participant weighting factor to each of a set of potential participants in a conference call, the set of potential participants including a first plurality of participants and a second plurality of participants; select from among a plurality of data centers an initial data center to host a conference call having participants on the conference call that include the first plurality of participants that have been associated with one of a first plurality of participant profiles, the selection being based at least in part on the first plurality of participant profiles; determine ahead of time which data center of the plurality of data centers to associate with each of a plurality of anticipated changes to the participants on the conference call, a one of the plurality of anticipated changes including the participants on the conference call changing to the second plurality of participants that have each been associated with one of a second plurality of participant profiles; in response to at least a change occurring in the participants on the conference call such that the participants on the conference call becomes the second plurality of participants, identify a data center that was determined earlier to be associated with the participants on the conference call becoming the second plurality of participants; and, handoff the conference call to the identified data center if the data center differs from the initial data center.

Example B17: The computer readable medium of example B16, wherein the computer is further instructed to: determine a first centroid using the participant weighting factors in the first plurality of participant profiles, the selection of the initial data center being based on the first centroid.

Example B18: The computer readable medium of example B17, wherein the computer is further instructed to: determine a second centroid using the participant weighting factors in the second plurality of participant profiles, the determining ahead of time to be based at least in part on the second centroid.

Example B19: The computer readable medium of example B18, wherein the respective participant profiles further include a respective participant location.

Example B20: The computer readable medium of example B16, wherein the second plurality of participant profiles each further include a respective participant location indicator, and the data center associated with the one of the plurality of anticipated changes corresponding to the participants on the conference call changing to the second plurality of participants is determined using the respective participant location indicators of the second plurality of participant profiles.

The foregoing descriptions of the disclosed embodiments have been presented for purposes of illustration and description. They are not intended to be exhaustive or to limit the scope of the claimed subject matter to the precise form(s) disclosed, and other modifications and variations may be possible in light of the above teachings. The embodiments were chosen and described in order to best explain the principles of the disclosed embodiments and their practical application to thereby enable others skilled in the art to best utilize the various embodiments and various modifications as are suited to the particular use contemplated. It is intended that the appended claims be construed to include other alternative embodiments except insofar as limited by the prior art.

What is claimed is:

1. A method for handing-off conference calls among data centers, the method comprising:
selecting, from among a plurality of data centers, an initial data center to host a conference call having participants on the conference call that include a first plurality of participants each associated with one of a first plurality of participant locations, the selection being based at least in part on the first plurality of participant locations;
determining ahead of time which data center of the plurality of data centers to associate with each of a plurality of anticipated changes to the participants on the conference call, a one of the plurality of anticipated changes corresponding to the participants on the conference call changing to a second plurality of participants each associated with one of a second plurality of participant locations;
in response to at least a change occurring in the participants on the conference call such that the participants on the conference call becomes the second plurality of participants, identifying a data center that was determined earlier to be associated with the participants on the conference call becoming the second plurality of participants; and
handing-off the conference call to the identified data center if the data center differs from the initial data center.

2. The method of claim 1, further comprising:
determining a first centroid using the first plurality of participant locations, the selection of the initial data center being based on the first centroid.

3. The method of claim 2, further comprising:
determining a second centroid using the second plurality of participant locations, the determining ahead of time to be based at least in part on the second plurality of participant locations.

4. The method of claim 1, wherein the first plurality of participants has more participants than the second plurality of participants.

5. The method of claim 1, wherein the first plurality of participants has fewer participants than the second plurality of participants.

6. The method of claim 1, further comprising:
distributing indicators of the plurality of anticipated changes and respectively associated data centers to at least one of the associated data centers.

7. The method of claim 1, wherein the indicators of the plurality of anticipated changes are not distributed to data centers that are not one of the respectively associated data centers.

8. A communication system, comprising:
an initial data center of a plurality of data centers to initially host a conference call having participants on the conference call that include a first plurality of participants each associated with one of a first plurality of participant locations, a selection of the initial data center being based at least in part on the first plurality of participant locations;
a handoff system that determines ahead of time a respective data center of the plurality of data centers to associate with each of a plurality of anticipated changes to the participants on the conference call, a one of the plurality of anticipated changes corresponding to the participants on the conference call changing to a second plurality of participants each associated with one of a second plurality of participant locations;
an identified data center of the plurality of data centers to host the conference call based on an ahead of time determination by the handoff system and a corresponding change occurring in the participants on the conference call such that the participants on the conference call becomes the second plurality of participants.

9. The communication system of claim 8, wherein the initial data center includes the handoff system.

10. The communication system of claim 8, wherein the selection of the initial data center is based on a first centroid determined from the first plurality of participant locations.

11. The communication system of claim 8, wherein the handoff system the ahead of time determination by the handoff system is based on a second centroid determined from the second plurality of participant locations.

12. The communication system of claim 8, wherein the selection of the initial data center is based on a first centroid determined from the first plurality of participant locations, the handoff system the ahead of time determination by the handoff system is based on a second centroid determined from the second plurality of participant locations, and the first centroid and the second centroid are geometric centroids.

13. The communication system of claim 8, wherein the first plurality of participants has more participants than the second plurality of participants.

14. The communication system of claim 8, wherein the first plurality of participants has fewer participants than the second plurality of participants.

15. The communication system of claim 8, wherein the handoff system distributes indicators of the plurality of anticipated changes and respectively associated data centers to the respectively associated data centers.

16. A non-transitory computer readable medium having instructions stored thereon for handing-off conference calls among data centers that, when executed by a computer, at least instruct the computer to:
select from among a plurality of data centers an initial data center to host a conference call having participants on the conference call that include a first plurality of participants each associated with one of a first plurality of participant locations, the selection being based at least in part on the first plurality of participant locations;
determine ahead of time which data center of the plurality of data centers to associate with each of a plurality of anticipated changes to the participants on the conference call, a one of the plurality of anticipated changes corresponding to the participants on the conference call changing to a second plurality of participants each associated with one of a second plurality of participant locations;
in response to at least a change occurring in the participants on the conference call such that the participants on the conference call becomes the second plurality of participants, identify a data center that was determined earlier to be associated with the participants on the conference call becoming the second plurality of participants; and
handoff the conference call to the identified data center if the data center differs from the initial data center.

17. The computer readable medium of claim 16, wherein the computer is further instructed to:
determine a first centroid using the first plurality of participant locations, the selection of the initial data center being based on the first centroid.

18. The computer readable medium of claim 17, wherein the computer is further instructed to:
determine a second centroid using the second plurality of participant locations, the determining ahead of time to be based at least in part on the second plurality of participant locations.

19. The computer readable medium of claim 18, wherein the computer is further instructed to:
distribute indicators of the plurality of anticipated changes and respectively associated data centers to at least one of the associated data centers.

20. The computer readable medium of claim 18, wherein the computer is further instructed to:
distribute indicators of the plurality of anticipated changes and respectively associated data centers to the respectively associated data centers.
